(19) United States
(12) Patent Application Publication
(10) Pub. No.: US 2013/0004620 A1
(43) Pub. Date: Jan. 3, 2013

(54) NUTRITIONAL ADDITIVE COMPOSITION

(75) Inventors: Brad Kifferstein, Birmingham, MI (US); Jeremy S. Belchinsky, Huntington Woods, MI (US); Paul Finder, Gilbert, AZ (US)

(73) Assignee: VITAPERK LLC, Birmingham, MI (US)

(21) Appl. No.: 13/253,483

(22) Filed: Oct. 5, 2011

Related U.S. Application Data
(60) Provisional application No. 61/389,904, filed on Oct. 5, 2010.

(51) Int. Cl. A23L 1/30; A23L 1/304; A23L 1/303; A23F 5/00; A23L 1/302

(52) U.S. Cl. 426/73

(57) ABSTRACT

The invention herein contemplates a nutritional additive composition providing health benefits and improved dissolution, appearance, and taste when added to solid food and liquids.

### CLAIM OF PRIORITY

The present application claims the benefit of the filing date of U.S. Provisional Application Ser. No. 61/389,904 (filed Oct. 5, 2010), the entirety of the contents of that application being hereby expressly incorporated by reference.

### FIELD OF THE INVENTION

This invention relates to a nutritional additive composition providing health benefits and improved dissolution and taste when added to solid food and liquids. This invention further relates to methods for adding customized nutritional value to common beverages post-purchase.

### BACKGROUND OF THE INVENTION

In an effort to improve health, consumers often seek simplified and improved means for ingesting necessary vitamins and minerals. Known methods for nutritional supplementation include supplements provided in pill form, bar form, shake form or the like, where a user must ingest a supplement that is separate from traditional food or drink. Examples include nutritional bars such as those disclosed in U.S. Pat. No. 6,576,253, and nutritional shakes such as that described in U.S. Pat. No. 6,562,869. Alternatively, some supplements are adapted for addition to food or beverage. Examples of such supplements can be found in U.S. Pat. Nos. 3,536,494; and 3,243,347 and U.S. Publication No. 2005/0186319. Many traditional methods for vitamin and mineral supplementation include poor taste, poor absorption, stomach upset, and a simple lack of availability when the supplement is desired. In addition, nutritional additives may result in discoloration or other undesirable side effects, such as effervescing, a lack of dissolution, or the like. Further, nutrient supplements are commonly added to food or beverage during production, prior to sale to a consumer.

Notwithstanding the above, there remains a need for a nutritional supplement that can be added to a food or beverage at will by a consumer, while either providing no taste effect to the food or beverage, or alternatively providing a specific flavor effect to the food or beverage, as desired by the consumer.

### SUMMARY OF THE INVENTION

The present teachings overcome one or more of the above needs by providing a nutritional additive that allows a consumer to add a variety of varying nutritional supplements directly to food or beverage while avoiding many of the problems expressed above. More specifically, the additive includes one or more flavorings and masking agents so that unappealing flavors from the various vitamins and minerals included in the nutritional additive are minimized. The nutritional additive may include n-hexadecanoate and calcium citrate. The nutritional additive may include malic acid. The nutritional additive may include magnesium. The nutritional additive may include at least about 0.05% n-hexadecanoate. The nutritional additive may include at least about 5% calcium citrate. The nutritional additive may include at least about 1% magnesium. The nutritional additive may include at least about 0.10% malic acid.

The present invention contemplates a nutritional additive composition comprising one or more vitamins, minerals, flavorings, and masking agents so that the additive can be added to food or beverage without deleteriously affecting the taste or appearance of the food or beverage. As a specific example, the additive may be added to coffee, tea, or coffee or tea related beverages. The additive may be substantially free of any vitamin, mineral, flavoring or masking agent that may affect the taste or appearance of the liquid. The additive may also include flavoring that enhances or compliments the taste of the food or beverage to which the nutritional additive is added. The additive may be added to a food or beverage by a consumer after purchase of the food or beverage.

### DETAILED DESCRIPTION

In general, the invention herein contemplates a nutritional additive composition and a method for adding customized nutritional value to common beverages post-purchase. The additive may include one or more vitamins, minerals, flavorings, and masking agents that enhance the ability of the additive to effectively dissolve to avoid unwanted appearance of the food or beverage to which the additive is included. The additive may be in powdered form.

The additive may include one or more vitamins selected from the group consisting of: n-hexadecanoate Vitamin A (Palmitate Vitamin A; Retinyl Palmitate), Vitamin C, Vitamin D3, Vitamin E, Thiamine, Niacinamide, Pyridoxine, Folic Acid, Cyanocobalamin, Biotin, Pantothenic Acid, and combinations thereof. The additive may contain at least about 0.01% n-hexadecanoate and less than about 5% n-hexadecanoate Vitamin A. The additive may contain from about 0.05% to about 0.8% n-hexadecanoate Vitamin A. The additive may contain at least about 0.03% Vitamin C and less than about 20% Vitamin C. The additive may contain from about 0.8% to about 5% Vitamin C. The additive may contain at least about 0.001% Vitamin D3 and less than about 5% Vitamin D3. The additive may contain from about 0.009% to about 0.1% Vitamin D3. The additive may contain at least about 0.01% Vitamin E and less than about 10% Vitamin E. The additive may contain from about 0.4% to about 5% Vitamin E. The additive may contain at least about 0.008% Thiamine and less than about 0.8% Thiamine. The additive may contain from about 0.01% to about 0.5% Thiamine. The additive may contain at least about 0.05% Niacinamide and less than about 5% Niacinamide. The additive may contain from about 0.1% to about 1% Niacinamide. The additive may contain at least about 0.008% Pyridoxine and less than about 4% Pyridoxine. The additive may contain from about 0, 01 to about 1% Pyridoxine. The additive may contain at least about 0.0009% Folic Acid and less than about 0.1% Folic Acid. The additive may contain from about 0.005% to about 0.03% Folic Acid. The additive may contain at least about 0.0009% Cyanocobalamin and less than about 0.8% Cyanocobalamin. The additive may contain from about 0.001% to about 0.1% Cyanocobalamin. The additive may contain at least about 0.08% Biotin and less than about 3% Biotin. The additive may contain from about 0.1% to about 1% Biotin. The additive may contain at least about 0.005% Pantothenic Acid and less than about 1% Pantothenic Acid. The additive may contain from about 0.009% to about 0.8% Pantothenic Acid.

The additive may include one or more minerals selected from the group consisting of: calcium, magnesium, manganese, chromium, and combinations thereof. The additive may contain at least about 5% calcium and less than about 80% calcium. The additive may contain from about 10% to about 70% calcium. The additive may contain at least about 2% magnesium and less than about 50% magnesium. The additive may contain from about 5% to about 38% magnesium. The additive may contain at least about 0.0005% manganese and less than about 0.5% manganese. The additive may contain from about 0.001% to about 0.1% manganese. The additive may contain at least about 0.0001% chromium and less than about 1% chromium. The additive may contain from about 0.001% to about 0.5% chromium.

The additive may include one or more flavor modifiers selected from the group consisting of: one or more fruit pectins, citric acid, fructose, erythitol, maltodextrin, lecithin, Lo Han, stevia, cocoa powder, and combinations thereof. The additive may include at least about 0.5% fruit pectins and less than about 20% fruit pectins. The additive may include from about 1% to about 10% fruit pectins. The additive may be substantially free of fruit pectins. The additive may include at least about 0.1% citric acid. The additive may include less than about 10% citric acid. The additive may include from about 0.3% to about 5% citric acid. The additive may be substantially free of citric acid. The additive may include at least about 5% fructose. The additive may include less than about 60% fructose. The additive may include from about 10% to about 40% fructose. The additive may be substantially free of fructose. The additive may include at least about 2% erythitol. The additive may include less than about 30% erythitol. The additive may include from about 5% to about 20% erythitol. The additive may be substantially free of erythitol. The additive may include at least about 0.1% maltodextrin. The additive may include less than about 10% maltodextrin. The additive may include from about 1% to about 5% maltodextrin. The additive may be substantially free of maltodextrin. The additive may include at least about 0.5% lecithin. The additive may include less than about 10% lecithin. The additive may include from about 0.5% to about 6% lecithin. The additive may be substantially free of lecithin. The additive may include at least about 0.5% Lo Han. The additive may include less than about 10% Lo Han. The additive may include from about 1% to about 5% Lo Han. The additive may be substantially free of Lo Han. The additive may include at least about 0.1% stevia. The additive may include less than about 10% stevia. The additive may include from about 0.5% to about 3% stevia. The additive may be substantially free of stevia. The additive may include at least about 0.1% cocoa powder. The additive may include less than about 10% cocoa powder. The additive may include from about 0.2% to about 4% cocoa powder. The additive may be substantially free of cocoa powder. The additive may further include one or more natural flavorings which may comprise from about 1% to about 20% of the additive.

The additive may also include one or more taste masking agents selected from the group consisting of malic acid, citric acid, fumaric acid, and combinations thereof. The additive may include at least about 0.01% masking agent. The additive may include less than about 10% masking agent. The additive may include from about 0.1% to about 5% masking agent.

The use of specific sources for certain vitamins and minerals may contribute to the flavor, dissolution capability, and coloring effect of the nutritional additive. As an example, the source of Vitamin A, the use of Retinyl palmitate (e.g., n-hexadecanoate Vitamin A), improves the dissolution capabilities of the Vitamin A as opposed to oil based sources of Vitamin A, such as Beta Carotene. Certain alternative sources of Vitamin A may also cause discoloration of any food or beverage to which the nutritional additive is added. The source of calcium may also affect flavor and dissolution capability, as will the source Potassium. Further, inclusion of specific amounts of certain masking and flavorings include malic acid, Lo Han and fructose, may contribute to enhancing flavor and limiting residual undesirable flavors that result from inclusion of certain vitamins and minerals.

The following nutritional additive compositions are given as illustrative examples and are not intended to limit the scope of the invention.

### Example 1

(3.4 g Serving Size)

| | |
|---|---|
| Vitamin A (palmitate) | 0.385% |
| Vitamin C (ascorbic acid) | 2.39% |
| Vitamin D3 (Cholecalciferol) | 0.031% |
| Vitamin E (acetate) | 2.31% |
| Thiamine HCL | 0.058% |
| Niacinamide | 0.77% |
| Pantothenic acid | 0.423% |
| Pyridoxine HCL | 0.077% |
| Folic Acid | 0.009% |
| Cyanocobalamin | 0.016% |
| Biotin | 0.78% |
| Calcium (malate) | 53.462% |
| Magnesium (citrate) | 28.846% |
| Manganese (chelate) | 0.019% |
| Chromium polynicatinate | 0.023% |
| Fruit pectins | 7.403% |
| Malic Acid | 1.5% |
| Citric Acid | 1.498% |

### Example 2

(3.4 g Serving Size)

| | |
|---|---|
| Vitamin A (palmitate) | 0.147% |
| Vitamin C (ascorbic acid) | 0.912% |
| Vitamin D3 (Cholecalciferol) | 0.012% |
| Vitamin E (acetate) | 0.882% |
| Thiamine HCL | 0.022% |
| Niacinamide | 0.295% |
| Pantothenic acid | 0.163% |
| Pyridoxine HCL | 0.03% |
| Folic Acid | 0.036% |
| Cyanocobalamin | 0.006% |
| Biotin | 0.3% |
| Calcium (malate) | 20.45% |
| Magnesium (citrate) | 11.2% |
| Manganese (chelate) | 0.008% |
| Chromium polynicatinate | 0.009% |
| Fructose | 29.0% |
| Malic Acid | 1.0% |
| Erythitol | 14.0% |
| Natural flavor | 10.52% |
| Maltodextrin | 3.508% |
| Lecithin | 3.0% |
| Lo Han | 2.5% |
| Stevia | 2.0% |

### Example 3

(3.4 g Serving Size)

| | |
|---|---|
| Vitamin A (palmitate) | 0.147% |
| Vitamin C (ascorbic acid) | 0.912% |
| Vitamin D3 (Cholecalciferol) | 0.012% |
| Vitamin E (acetate) | 0.882% |
| Thiamine HCL | 0.022% |
| Niacinamide | 0.295% |
| Pantothenic acid | 0.163% |
| Pyridoxine HCL | 0.03% |
| Folic Acid | 0.036% |
| Cyanocobalamin | 0.006% |
| Biotin | 0.3% |
| Calcium (malate) | 20.45% |
| Magnesium (citrate) | 11.2% |
| Manganese (chelate) | 0.008% |
| Chromium polynicatinate | 0.009% |
| Fructose | 33.5% |
| Malic Acid | 0.5% |
| Erythitol | 15.5% |
| Natural flavor | 5.0% |
| Maltodextrin | 3.972% |
| Lecithin | 3.0% |
| Lo Han | 2.0% |
| Stevia | 1.0% |
| Cocoa powder | 1.0% |

### Example 4

(3.4 g Serving Size)

| | |
|---|---|
| Vitamin A (palmitate) | 0.147% |
| Vitamin C (ascorbic acid) | 0.912% |
| Vitamin D3 (Cholecalciferol) | 0.012% |
| Vitamin E (acetate) | 0.882% |
| Thiamine HCL | 0.022% |
| Niacinamide | 0.295% |
| Pantothenic acid | 0.163% |
| Pyridoxine HCL | 0.03% |
| Folic Acid | 0.036% |
| Cyanocobalamin | 0.006% |
| Biotin | 0.3% |
| Calcium (malate) | 20.45% |
| Magnesium (citrate) | 11.2% |
| Manganese (chelate) | 0.008% |
| Chromium polynicatinate | 0.009% |
| Fructose | 36.0% |
| Malic Acid | 1.0% |
| Erythitol | 13.0% |
| Natural flavor | 6.8% |
| Maltodextrin | 2.728% |
| Lecithin | 3.0% |
| Lo Han | 2.0% |
| Stevia | 1.0% |

The additive may include a vitamin blend, one or more fruit pectins, malic acid, and citric acid. The additive may include a vitamin blend, fructose, erythitol, natural flavoring, lecithin, maltodextrin, Lo Han, stevia, and malic acid. The additive may include a vitamin blend, fructose, erythitol, natural flavoring, lecithin, maltodextrin, Lo Han, stevia, cocoa powder, and malic acid. The vitamin blend may include vitamin A, vitamin C, vitamin D, vitamin E, vitamin B1, vitamin B3, vitamin B5, vitamin B6, vitamin B12, folic acid, biotin, calcium, magnesium, manganese, chromium, and combinations thereof. The source of vitamin A may be palmitate. The source of vitamin C may be ascorbic acid. The source of vitamin D may be cholecalciferol. The source of vitamin E may be acetate. The source of vitamin B1 may be thiamine HCL. The source of vitamin B3 may be niacinamide. The source of vitamin B5 may be pantothenic acid. The source of vitamin B6 may be pyridoxine HCL. The source of vitamin B12 may be methylcobalamin. The source of calcium may be calcium malate. The source of magnesium may be magnesium citrate. The source of manganese may be manganese chelate. The source of chromium may be chromium polynicatinate. An example of a possible vitamin blend is listed below as Example 5.

### Example 5

(Vitamin Blend)

| | | |
|---|---|---|
| Vitamin A (palmitate) | 100 | iu |
| Vitamin C (ascorbic acid) | 30 | mg |
| Vitamin D3 (cholecalciferol) | 200 | iu |
| Vitamin E (acetate) | 15 | iu |
| Thiamine HCL | 250 | mcg |
| Niacinamide | 10 | mg |
| Pantothenic acid | 1 | mg |
| Pyridoxine HCL | 1 | mg |
| Folic Acid | 120 | mcg |
| Cyanocobalamin | 2 | mcg |
| Biotin | 100 | mcg |
| Calcium (malate) | 250 | mcg |
| Magnesium (citrate) | 60 | mg |
| Manganese (chelate) | 60 | mcg |
| Chromium polynicatinate | 30 | mcg |

The vitamin blend may be included with additional ingredients to comprise an illustrative additive of the present invention. Examples 6 through 9 describe example embodiments of the additive described herein. The following nutritional additive compositions are given as illustrative examples and are not intended to limit the scope of the invention.

### Example 6

(1.3 g Serving Size)

| | |
|---|---|
| Vitamin blend | 92.0% |
| Fruit pectins | 5.0% |
| Malic acid | 1.5% |
| Citric acid | 1.5% |

### Example 7

(3.4 g Serving Size)

| | |
|---|---|
| Vitamin blend | 40.0% |
| Fructose | 27.0% |
| Erythitol | 13.0% |
| Natural flavoring | 9.0% |
| Lecithin | 3.0% |
| Maltodextrin | 3.0% |
| Lo Han | 2.0% |
| Stevia | 2.0% |
| Malic Acid | 1.0% |

### Example 8

(3.4 g Serving Size)

| | |
|---|---|
| Vitamin blend | 34.0% |
| Fructose | 33.5% |
| Erythitol | 16.0% |
| Natural flavoring | 5.0% |
| Lecithin | 3.0% |
| Maltodextrin | 4.0% |
| Lo Han | 2.0% |
| Stevia | 1.0% |
| Malic Acid | 0.5% |
| Cocoa powder | 1% |

### Example 9

(3.4 g Serving Size)

| | |
|---|---|
| Vitamin blend | 34.0% |
| Fructose | 36.0% |
| Erythitol | 13.0% |
| Natural flavoring | 7.0% |
| Lecithin | 3.0% |
| Maltodextrin | 3.0% |
| Lo Han | 2.0% |
| Stevia | 1.0% |
| Malic Acid | 1.0% |

The additive may be substantially free of certain vitamins, minerals and other substances that may prevent the additive from effective dissolution in a food or liquid. The additive may also be substantially free of certain vitamins, minerals and other substances that may deleteriously affect the taste of a food or liquid to which the additive is applied. As an example, the additive may be substantially free of zinc. The additive may also be substantially free of riboflavin. The additive may also be substantially free of copper.

The source of the vitamins and minerals within the additive may have specific characteristics to improve the function of the additive. As an example, the source of vitamin A may be palmitate and the additive may be substantially free of beta carotene as a source of vitamin A. The source of calcium may be calcium citrate and the additive may be substantially free of di-calcium phosphate as a source for calcium.

The additive described herein may be added to a food or beverage post-purchase, thus allowing the consumer to determine the nature and amount of the additive to be consumed: As an example, the additive may be added to a coffee or tea product after purchase, such that a pre-packaged amount of additive will effectively provide nutritional substance without deleterious change (e.g., to the appearance, texture or taste) to the coffee or tea product. Alternatively, the additive may be added to a food or beverage prior to purchase and/or prior to consumption by a consumer.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” Or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

It will be appreciated that concentrates or dilutions of the amounts recited herein may be employed. In general, the relative proportions of the ingredients recited will remain the same. Thus, by way of example, if the teachings call for 30 parts by weight of a Component A, and 10 parts by weight of a Component B, the skilled artisan will recognize that such teachings also constitute a teaching of the use of Component A and Component B in a relative ratio of 3:1. Teachings of concentrations in the examples may be varied within about 25% (or higher) of the stated values and similar results are expected. Moreover, such compositions of the examples may be employed successfully in the present methods.

It will be appreciated that the above is by way of illustration only. Other ingredients may be employed in any of the compositions disclosed herein, as desired, to achieve the desired resulting characteristics. Examples of other ingredients that may be employed include antibiotics, anesthetics, antihistamines, preservatives, surfactants, antioxidants, unconjugated bile acids, mold inhibitors, nucleic acids, pH adjusters, osmolarity adjusters, or any combination thereof.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A powdered coffee additive comprising:
vitamin A Palmitate;
calcium citrate; and
malic acid.

2. The powdered coffee additive of claim 1, wherein the additive comprises:
at least about 0.05% vitamin A Palmitate at least about 5% calcium citrate;
at least about 1% magnesium; and
at least about 0.10% malic acid.

3. The powdered coffee additive of claim 1, wherein the additive includes vitamin C, vitamin D, vitamin E, vitamin K, or any combination thereof.

4. The powdered coffee additive of claim 1, wherein the additive includes a B vitamin selected from the group consisting of thiamine, niacinamide, pyridoxine, folic acid, cyanocobalamin, biotin, pantothenic acid, and any combination thereof.

5. The powdered coffee additive of claim 1, wherein the additive includes at least about 20% calcium citrate.

6. The powdered coffee additive of claim 1, wherein the additive includes at least about 10% magnesium.

7. The powdered coffee additive of claim 1, wherein the additive includes at least 20% fructose.

8. The powdered coffee additive of claim 1, wherein the additive is added to a coffee drink by a consumer.

9. The powdered coffee additive of claim 1, wherein the additive includes at least about 1% and less than about 2% malic acid.

10. The powdered coffee additive of claim 1, wherein the additive includes at least about 1% Lo Han.

11. The powdered coffee additive of claim 1, wherein the additive includes less than about 5% Lo Han.

12. The powdered coffee additive of claim 1, wherein the additive includes less than about 2% Lo Han.

13. The powdered coffee additive of claim 1, wherein the additive is substantially free of riboflavin.

14. The powdered coffee additive of claim 1, wherein the additive is substantially free of zinc.

15. The powdered coffee additive of claim 1, wherein the additive is substantially free of copper.

16. A powdered coffee additive comprising:
from about 0.1% to about 0.5% vitamin A Palmitate;
from about 18% to about 55% calcium citrate;
from about 8% to about 40% magnesium;
from about 0.5% to about 4% malic acid; and
from about 1% to about 10% B vitamins selected from the group consisting of thiamine, niacinamide, pyridoxine, folic acid, cyanocobalamin, biotin, pantothenic acid, and any combination thereof.

17. The powdered coffee additive of claim 16, wherein the additive is substantially free of riboflavin.

18. The powdered coffee additive of claim 16, wherein the additive is substantially free of zinc.

19. The powdered coffee additive of claim 16, wherein the additive is substantially free of copper.

20. The powdered coffee, additive of claim 16, wherein the additive includes vitamin C, vitamin D, vitamin E, vitamin K, or any combination thereof.
